(19) United States
(12) Patent Application Publication
(10) Pub. No.: US 2026/0217393 A1
(43) Pub. Date: Jul. 30, 2026

(54) BLOWN WING PROPROTOR-DRIVEN POWERED-LIFT AERODYNE

(71) Applicant: National Research Council of Canada, Ottawa (CA)

(72) Inventors: Zekai HONG, Ottawa (CA); Trevor PHAIR, Ottawa (CA)

(73) Assignee: National Research Council of Canada, Ottawa, ON (CA)

(21) Appl. No.: 19/145,832

(22) PCT Filed: Jan. 10, 2024
(86) PCT No.: PCT/IB2024/050257

§ 371 Date: Jul. 3, 2025

Related U.S. Application Data
(60) Provisional application No. 63/438,361, filed on Jan. 11, 2023.

(51) Int. Cl. B64U 30/29; B64U 10/20; B64U 30/10

(52) U.S. Cl. CPC B64U 30/29; B64U 10/20; B64U 30/10

(57) ABSTRACT

A proprotor-driven powered-lift aircraft (PPLA) has at least four proprotors, each of which, in rotation, sweeping a respective annulus of radial extent re that covers, by axis-orthogonal projection, a collective length of 2.1×rₑ of parallel leading edges of two or more wings to provide a blown wing enhancement that permits pitch transition during flight with greater control throughout the transition. The PPLA preferably has at least three substantially parallel wings, and at least four proprotors, each of which proprotors: affixed to a bracing extended between two of the at least three wings. Hover mode and forward flight modes can both have excellent control, allowing for better flight efficiency.

### FIELD OF THE INVENTION

The present invention relates in general to proprotor-driven powered-lift aircraft (PPLA) and, in particular, to PPLAs having an arrangement of proprotor blades with respect to leading edges of the wings that provides a blown wing enhancement to the PPLA, by increasing a critical angle of attack of the PPLA.

### BACKGROUND OF THE INVENTION

PPLAs include manned and unmanned, piloted, remotely controlled or guided, or autonomous, aerodynes and the term designates aerodynes capable of VTOL and low-speed flight, in a first mode (herein ‘hover’) that depends principally on rotor thrust of the proprotor, and also capable of higher efficiency, higher speed flight (herein ‘forward flight’) that makes substantial use of lift created by fixed wings, and propulsion is produced by prop thrust of the proprotor. Thus the PPLA, like all other powered lift aircraft, is in one mode a fixed-wing, and in another mode a rotary-wing, aerodyne. The term convertiplane is sometimes also used for PPLAs, typically when some parts of the plane are reoriented via some articulation. Various PPLAs offer VTOL/hover capabilities and higher efficiency forward flight (range extension) have been researched and are under development.

The only classes of PPLAs widely known are tilt-propeller, tilt-shaft, tilt-rotor and tilt-wing (collectively herein referred to as tilt-*). Different PPLAs employ a variety of strategies to enable hover flight with limited or no fixed-wing lift: the PPLA may have an augmented power plant for use during hover, a separate power plant (that is combined, or not) with a forward flight power plant for hover, or a same propulsion can be used for hover and forward flight. Most PPLA designs, typically allow for the same thrusters to be used for all flight modes (hover, forward flight, and possibly any intermediate modes). Whether the power plants and/or the thrusters are the same, or separate, makes a big difference to the cost effectiveness of the design. In general, thrusters and power plants optimized for forward flight, are not as well optimized for hover, both from the aerodynamics, weight, and power considerations. Advantages in optimized thrust are traded off against the weight and cost penalties of separate thrusters. The weight, costs, and complexities of actuation are substantial concerns for tilt-* PPLA designs.

The ring-wing tailsitter is a good example of a PPLA that is not a tilt-*. Bell's Hydra 1™, for example is a 12-copter ring-wing tailsitter that is well suited to hover, and adapted to have some wing-based lift in forward flight. Unlike the other tilt-* designs, if it is a convertiplane, it has no perceptible change in form or articulation, but only in orientation (i.e. pitch) before and after transition. While the designation ‘tailsitter’ may be satisfactory by some counts, a vast majority of tailsitters are flying wing, monoplane, biplane, or x wing varieties, and expressly not box-wing or ring-wing structures. As landing gear and orientation with respect to airframe on landing are inherently variable, landing orientation would appear to be an arbitrary means to classify aircraft, and so Hydra 1 might be in a distinct class of “non-tilt-* PPLAs”. Herein non-tilt-* PPLAs are understood to be PPLAs that have proprotors on fixed axes relative to an air frame of the PPLA. As such, the air frame is designed to hover, with rotor thrust from proprotors, and, after pitch transition, to fly in forward flight propelled by prop thrust, with no jointed articulation of the airframe between the proprotor and at least most of the air frame (including fuselage, centrebody, or hold).

Added to the large variety of PPLAs are the varieties of use cases, and flight missions. A PPLA rarely intended for hovering except during landing, might be expected to resemble a long-haul aircraft, with an extended fuselage, but with additional flight control systems for hover and controlled descent. In contrast, a PPLA intended for hovering most of the time, but requiring brief periods of “commuting” (in forward flight) between stops, might be expected to look like a modified rotorcraft. All of the use cases and trade-offs have led to a proliferation of PPLA designs, and yet few designs offer high stability and effectively controlled PPLAs in both forward flight and hover, using only a small number of flight control surfaces and thrusters, and few or no large scale actuators. In particular, flight control during pitch transition between hover and forward flight is challenging.

U.S. Pat. No. 11,014,664 to North et al. teaches a structure that ostensibly uses vectored thrust to permit an aircraft to hover in any orientation using (possibly) only 3 thrusters, each mounted to pivot 90°. With enough thrust an object, no matter how unwieldy, can be piloted, however the costs of flight and fuel efficiency may make such a structure expensive to operate. Furthermore, interactions with the aircraft and the thrusters in some orientations might prove to make such an aircraft a challenge to operate in a steady wind, and particularly challenging in gusting conditions. This is an example of a PPLA design with large amplitude, large force actuations of large scale components to enable a single set of thrusters to be used in both hover and forward flight. The large amplitude, large force actuations are undesirable in terms of space, weight, and power efficiency, but the same propulsion system for both flight modes is desirable by the same criteria. The large scale actuations lead to a very wide number of possible air-structure interactions that require very costly and time consuming study to certify. This is also an example of an aircraft that is better suited aerodynamically to forward flight than hover.

Hydra 1 is a good example of a 12-copter PPLA that is well suited to hover, and adapted to have some wing-based lift in forward flight. The amount of lift, however, is quite limited as only about half of the ring and wye wings contributing to lift. Well distributed, parallel-axis many rotor (4+) PPLA designs are generally very well controlled aerodynamic structures, capable of hover, and responsive in the most challenging of flight conditions. Forward flight with these PPLA designs are expected to be reasonably controllable too. However pitch transitions between hover and forward flight are expected to be highly unstable, with the PPLA losing lift for the duration that the angle of the rotors provides less lift than weight, and the wings are not oriented to generate more lift than drag.

As is known in the art, a critical angle of attack of a wing with respect to a freestream is a fixed angle above which lift and drag coefficients abruptly change. Wings of PPLA have critical angles of attack of 5-15°, typically. Herein we will measure angles from gravity for reference. In hover mode, to provide safe, stable operations the PPLA's pitch may remain within a range of ±30°, although some go as high as 40°, and much higher angles are used for racing. Ignoring aerodynamic effects, the thrust of a hovering PPLA available to counter gravity is proportional to the cosine of this angle. Depending on available thrust, and weight, the PPLA will lose altitude when an angle is exceeded, this angle may be about 60°, where the rotors are directing thrust at a vector that offers half the force to counteract gravity, at about 66° where less than 40% of the thrust counters gravity, or at 75.5° where about ¼ of the force is directed against gravity. Provisioning a PPLA to provide greater thrust substantially increases costs, energy demands, fuel/charge requirements, and decreases flight distances and duration. Therefore throughout pitching from the angle 0° to 60°, the hover mode would typically counteract gravity, but somewhere between 60° and 75° to 80° (i.e. the angle complementary to the angle of attack), the aircraft's thrust will not be countered by thrust, and yet barely any lift is generated by wings relative to drag, and so the aircraft will fall. During this fall there are limited options for control, and response to gusts.

The only known strategies for dealing with this inherent loss of control are to reduce the time of pitching, or accept the loss of control and increase altitude before the maneuver. The pitching time can be reducing by decreasing a pitching moment of the PPLA (mass distribution, and aerodynamic loads); increasing a thrust differential by providing larger forces; and/or applying the thrusts further from a centre of mass of the PPLA. None of these address the issue, and lack of control fundamentally precludes PPLA operation in constrained environments (near buildings and people), or where loss of control risks are unacceptable.

A less conventional looking PPLA is disclosed by U.S. Pat. No. 10,336,450 to Graham. The “compact personal aircraft” CPA of Graham has a boxed planform multi-wing assembly that shares many advantages with “tailsitter” designs. Although the aircraft looks anything but compact, except in the forward-aft direction, the multi-wing design does allow for a shorter span. There are no large-scale actuations required, the same thrusters and power plants are useful in each mode of operation, and no dynamic airfoil control surfaces are needed. Thus only 4 propellers are used in all modes from hover to forward flight. Again, excellent control is possible in the hover mode, with known algorithms for quadcopters, and the structure is likely amenable to good control in forward flight. Pitch transition may be worse, in comparison with the Hydra 1 design, as all wing surfaces are co-oriented, leading to highly different response and moments depending on aerodynamic loads. For the same reason, though, the CPA will have far greater lift in forward flight, and better fuel efficiency and range capabilities relative to the Hydra 1 if similarly equipped and built.

Tailsitters, for stable operation in hovering mode, typically have a plurality of propellers that are distributed maximally around the aircraft, as in the CPA. For Graham's purposes, maximal distribution of the propellers improves responsiveness in hover mode, and would appear to be crucial for the ability to pitch the CPA the full 90° against the “enhanced pitching moment of inertia” of the rectangular box-wing design relative to a VTOL aircraft with an elongated fuselage.

Graham observes an adverse control in hover mode due to “blown wing” effects: “Although during VTOL, the blown wing effect may produce some horizontal lift components incumbent upon the multi-wing assembly designed static angle of attack, such effect can be compensated for and the attitude stability of the CPA maintained entirely by the dynamically controlled quad-rotor air propulsion system.” (C4;L33) While the static angle of attack and optionally camber of the wings, could be useful for better efficiency in forward flight, it may be difficult to stably control the CPA in a fixed hover. Greater flight efficiency in forward flight mode comes at some cost to hover control of the CPA, making landing on a mark without a controlled and steady cross-wind to compensate for the “horizontal lift components”, difficult.

The CPA, with its unconventional format, has a lot of merit for a certain set of application spaces. While multi-wing planes have generally fallen out of mode since the early days of aviation because of a lower fuel efficiency and lower speed that come with increased drag: the quadcopter design has excellent stability and responsiveness. Also, shortened wingspan of PPLAs may become increasingly of interest for operation in more constrained environments, such as in urban settings, within and between buildings.

Control throughout the 90° pitching (schematically illustrated but not demonstrated by Graham) matters. Contrary to what was schematically shown, the CPA was not demonstrated to pitch until the angle of attack and airspeed provide lift without losing altitude. Applicant expects the CPA to lose substantial altitude while pitching, and a magnitude and rate of the pitch transition fall to depend on flight conditions.

Thus, in conclusion, tilt-* and vectored thrust designs require development of control algorithms that require much study in respect of numerous flight control surfaces and operating conditions, when large scale actuations are performed on aerodynamics-affecting structures. The costs of the study, the weight and costs of the flight control surfaces required to permit the operations in variable conditions, and risks of loss of control and increased workload of pilots during pitch transition, are serious impediments to tilt-* PPLAs. There remains a need for improved PPLA design that: avoids large scale actuations, secondary power plants, and/or propellers; augments fixed wing lift in forward flight for improved flight efficiency/payload/range; and improves PPLA control throughout pitch transition. In particular, a PPLA thrusted by, or substantially by, a multi-copter system with at least 4 rotors fixed with parallel axes, to allow well established control laws to be deployed with less research and development is desired. The PPLA design may preferably consist essentially of a lattice structure of at least 4 substantially parallel wings interconnected by at least 2 struts between wings.

### SUMMARY OF THE INVENTION

Applicant has invented a PPLA making a new application of the known blown-wing effect. While the blown wing may have been an obstacle to control over the CPA when operating in hover mode, according to Graham, the present disclosure teaches how to leverage this effect to improve control, especially during pitch transition.

The blown wing effect increases attachment, and substantially reduces critical angle of attack limitations of symmetric airfoils. Blown wings can generate lift at nearly twice the angle of attack at which the same wing (not blown) stalls. By substantially increasing the amount of blown wing (i.e. surface area blown), the wings generate more lift throughout more of the pitch transition, which decreases the pitching window of fall. In addition to the improved control, a reduced moment is provided with slight centralization of proprotors (that is, as the proprotor has a higher mass density than the wings, moving them torwards a centre of gravity decreases moment for pitch, yaw and roll). The design also invites larger radius blades. The increased angle of attack and decreased moment can offset the mechanical disadvantage (torque) of proprotor centralization, and enable better controlled pitch transition. Applicant has demonstrated a remarkably good stability of flight throughout the pitch transition. Moving the proprotors towards centre also reduces risk of proprotor strike, without adding ducts or shrouds.

While the prior art teaches fast pitch transition, it requires higher thrust proprotors to maintain flight during pitch transition, uses maximally decentralized proprotors to improve thrust torque for pitching and better control, and/or simply accepts loss of altitude and control during pitch transition, leveraging blown wing enhancement is an entirely different approach. The transition can be slower and under better control as will be required for flights that transition in constrained spaces, or under gusting conditions.

To leverage blown wing advantages in PPLA design, each proprotor is arranged to produce thrust, and also project (blow) air over at least two respective wings, increasing lift (as well as drag). Thus a blown wing PPLA can be designed to centralize proprotors, and increase blown surface area of the wings (i.e. principal airfoils). Herein centralization of proprotors means placing them closer together than in the prior art, but still providing the thrust of at least one proprotor right of a vertical axis of the PPLA, one left of the vertical axis, one above a lateral axis and one below the lateral axis. Each of these at least one proprotors being mutually operable rate-independently of the others of the at least one proprotors. That is, the proprotor below the lateral axis, if it is not also the proprotor to the left of the vertical axis, can be operated at a different angular velocity as the proprotor to the left of the vertical axis. This ensures that if flight directives and conditions call for a correction in attitude, these four sets of at least one proprotor is independently controllable to apply a torque to tilt the PPLA, in hover.

The PPLA has at least 3 stacked wings, with suitable bracing (e.g. vertical stabilizers or anhedral/dihedral struts/wings). Proprotors may be mounted on wings, but it is generally advantageous to mount proprotors to bracing in-between two wings to facilitate blowing of two wings. Surface area blown is a complex aerodynamic measure that depends on operating conditions, so for this invention is characterized by other measures. As each proprotor blade's sweeps an annulus having a radial extent rₑ, one can consider how much leading edge of the wings are covered by the blade. ‘Covered’ here refers to orthogonally projected in the direction of the heading vector of the PPLA in nominal forward flight (which differ from an axis of the proprotor by at most 16°. So a proprotor mounted on a first wing can cover 2×rₑ a length of the leading edge of the first wing, and no more (assuming the leading edge is linear). Coverage of at least 2.1×rₑ provides a blown wing enhancement. Coverage of 2.5× to 4×rₑ are preferred. Herein each range (closed or open) is intended to specifically disclose all subranges thereof.

A first limit on increasing blown wing in PPLA design comes from the minimum separation between wings. To ensure substantially unimpeded airflow over each wing, separation of the wings should be at least about 1.25 a chord length of the wings (l_{c}), although, with a substantial penalty in the lift to drag ratio, a separation may be between 0.75× and 1.25×l_{c}, especially if the wings are staggered, as explained hereinbelow. There is little aerodynamic advantage to separation of more than 3×l_{c}, and in practice a separation of wings is expected to be between 1.25× to 2.5×l_{c}. A second limit is the drag associated with the wings and bracing, that is increased relative to prior art. Thus, like the CPA, this design has wings that are rather compact in the fore-aft direction (chord), possibly narrower in the span direction, and substantially higher, than other PPLAs.

For better stability control in hover, with the least modification of existing quad or multicopter control systems, it is preferred to use wings having symmetric airfoils. Otherwise the lift provisioned by the wing camber in hover mode, will induce a default forward motion: to generate lift is to also induce forward motion. While this may be of benefit to some PPLAs for some use cases, providing a stationary hover would require a significant pitch angle, and may require substantial workload. A higher flight efficiency in forward flight can be provided with cambered wings.

The vertically extended stabilizers are one preferred form of bracing for wings of a PPLA. A vertical stabilizer will typically extend a whole chord length of the wing, and at least peripheral (i.e. furthest from yaw axis on either side) bracing is preferably of this form to avoid angular dependence on gust in hover mode. The peripheral stabilizers and bottom and top wings may form a peripheral box-wing, or wing tip extensions of the wing may extend beyond the peripheral stabilizers, for example, the peripheral stabilizers may be located at 60% to 90% of the span of the PPLA. Short wing tips and stabilizer tips that extend above the top wing and below the bottom wing may improve proprotor tip strike protection without adding bulky shrouds.

The PPLA may use staggered wings (i.e. top wing forward of a middle wing, forward of the bottom wing by some fraction of the chord length, which can be from negligible to 40%). Staggering the wings provides an improvement in lift to drag ratio for the PPLA. The wings can have a variety of shapes and aspects: they can be dihedral, anhedral (or both like a gull wing); swept (forward or back, or variably swept); or tapered (regular, reversed, or variable). The wing can have a gradual change in chord, or profile as a function of distance from root to tip, such as elliptical, or semi-elliptical planform, and can have the usual variety of tips, such as raked, sharklet, or fenced winglets.

The blown wing PPLA may be a lattice wing structure, having a substantially regular 2D array of bays, although some central bays may be irregularly sized if bounded by a centerbody, cabin, or hold. The wings may be equispaced and nominally substantially parallel, as may be the bracing. The bracing may have a similar aspect ratio as the wings, or may be thinner.

Accordingly a first proprotor-driven powered-lift aircraft (PPLA) is provided. The PPLA has at least four proprotors, each of which driven about a respective axis no more than 16° from a heading vector of the PPLA in nominal forward flight, to sweep a respective annulus of radial extent rₑ that covers, by axis-orthogonal projection, a collective length of 2.1×rₑ of leading edges of two or more wings, with at least one set of at least one independently operated proprotor with an axis in each quadrant defined by pitch and yaw axes the PPLA. More preferably the collective length covered is 2.5-4×rₑ.

Also accordingly, a second proprotor-driven powered-lift aircraft (PPLA) is provided having at least three substantially parallel wings and at least four proprotors, each of which proprotors: having a longitudinal axis no more than 16° from a heading vector of the PPLA in forward flight; affixed to a bracing extended between two of the at least three wings; and having a blade radius rₑ sufficient to blow at least 2.1×rₑ of leading edges of two or more wings, including at least 2% of a span of each of the two wings.

The axes of at least four of the at least four proprotors of either the first or second PPLA may be spatially arrayed to form a convex polygon projected in a plane of the heading vector, the polygon having no interior angle less than 35°, and a standard deviation of the interior angles is less than 50% of the average of the interior angles. A constellation of the axes in the plane may be symmetric about a projection of the yaw axis of the PPLA, and/or a projection of the pitch axis of the PPLA.

Such PPLA includes an airframe, preferably comprising an airframe structure supporting the wings that comprise at least four stacked airfoils so that each airfoil: has a chord oriented generally in the direction of the heading vector; has a chord length l_{c}; and is separated from an adjacent airfoil by a distance of at least 1.25×l_{c}, or more preferably 1.5×l_{c}, and less than 5×l_{c}.

The supporting structure may include substantially full chord struts having aerodynamic contours to serve as vertical stabilizers separating adjacent airfoils, and the full chord struts, airfoils, and hold preferably define at least 4 bays for airflow within a periphery of the PPLA: more specifically each bay is defined between two adjacent struts or a hold and a strut, and between two airfoils or an airfoil and a hold. The annulus swept by at least one of the proprotors covers, by axis-orthogonal projection, at least parts of at least 4 bays or baylets, each baylet bounded by 3 sides by airfoils, stabilizers, and the hold. All bays may have similar hydrodynamic resistances.

The vertical stabilizers may include a set that extend between each adjacent airfoil on both sides, at between 55% and 100% span.

The wings and stabilizers may define a lattice structure. The PPLA may not have a canard or empennage.

The PPLA may further comprise a rotund central body with a hold. The central body may comprise a turret mount for at least one passive, 1 DoF rotation. The turret mount may be passively driven by a center of gravity to orient support for an occupant. The turret mount may comprise a trunnion or at least one rail and rollers or slides for coupling the central body and hold to the support structure.

Two or more neigbouring proprotors may sweep overlapping annuli, as long as the proprotors have coordinated phase. Preferably they are commonly driven.

The airfoils may be symmetric such that its camber line is its chord line, the airfoils are fixedly mounted to an airframe.

The PPLA may substantially consist of the airfoils, supports, and a hold, having no flight control surfaces other than the proprotors, which are of variable pitch.

The PPLA may by a nose-sitter or a tail-sitter.

A copy of the claims as filed and a copy of the current claims are incorporated herein by reference. Further features of the invention will be described or will become apparent in the course of the following detailed description.

### BRIEF DESCRIPTION OF THE DRAWINGS

In order that the invention may be more clearly understood, embodiments thereof will now be described in detail by way of illustration, with reference to the accompanying drawings, in which:

FIGS. 1A,B are, (in forward flight) respectively, frontal and side elevation views of a first embodiment of a lattice PPLA of the present invention, the PPLA having 5 wings braced by stabilizer/struts, propelled by 4 proprotors;

FIGS. 2A,B are respectively, frontal and side elevation views of a first variant of the PPLA of the present invention, this PPLA has a staggered lattice box-wing form, with 5 wings, braced by stabilizers/struts, driven by 6 proprotors of two respective sizes, featuring a centrebody shaped for aerodynamic effect in forward flight, the views of which matching those of FIG. 1;

FIG. 3 is a frontal view of a second variant of the PPLA of the present invention having lattice box-wing form, the PPLA having 6 anhedral wings, 5 stabilizers, and 8 proprotors, wherein the proprotors are of two respective sizes, and a centrebody is shaped for better aerodynamic effect in forward flight;

FIG. 4 is a frontal view (in forward flight mode), of a third variant of the PPLA having lattice box-wing form of the present invention, the PPLA having 9 wings, 4 stabilizer/struts (2 of which are partial), and 9 proprotors, including one central, proprotor surrounding a centrebody, and including a strut other than an vertical stabilizer;

FIGS. 5A,B are two orthogonal views (matching those of FIG. 1) of a fourth variant of the PPLA with swept wing form, the PPLA having 5 wings, 2 stabilizer/struts, for which a centerbody wing is unblown;

FIGS. 6A, B are two orthogonal views (matching those of FIG. 1) of a fifth variant of the PPLA, the PPLA having two pair of staggered wings, two stabilizer/struts interconnecting each pair, and one centrebody stabilizer bracing the four wings together;

FIG. 6C shows a frontal view of a variant of the fifth variant with three pairs of the wings;

FIG. 6D shows a frontal view of a sixth variant of a PPLA in accordance with the invention having: 4 wings, including two long span wings sandwiched by two short span wings; one centerbody interconnecting the wings in a stabilizer direction (perpendicular to wings); two stabilizers for bracing the long span wings for supporting respective central proprotors; and symmetrically dihedrally and anhedrally disposed bracing for supporting respective peripheral proprotors;

FIG. 7 shows a frontal view of a seventh variant of a PPLA in accordance with the invention having a decidedly non-lattice design, nonetheless the PPLA has 4 wings, or wing segments, 6 proprotors, including 4 of which timing coupled for non-collision, and one of which being a peripherally driven hubless proprotor:

FIG. 8 shows a frontal view of an eighth variant of a PPLA in accordance with the invention having an exoskeletal box-wing design, featuring 4 decentralized holds, 5 wings, 9 proprotors, including 4 of which timing coupled for non-collision, and a central one of which having a largest radius;

FIG. 9 shows a frontal view of a ninth variant of a PPLA in accordance with the invention having no vertical stabilizer, but only two pairs of dihedral and anhedral struts for bracing the 4 wings and centerbody, and mounting the proprotors, which in this case are 3 bladed;

FIGS. 10A,B are photographs of a prototype PPLA;

FIGS. 11A,B are graphs showing pitch and altitude as a function of time during pitch transition from over to forward flight in accordance with a fast, and a slow pitch transitions, respectively;

FIG. 12 is a scatter plot of throttle as a function of pitch; and

FIG. 13 is a scatter plot of altitude error as a function of pitch.

### DESCRIPTION OF PREFERRED EMBODIMENTS

Herein a PPLA with blown-wing enhancement is disclosed. Blown-wing PPLA structures exhibit improved control, particularly with multi-proprotor driven flight control in hover mode, and extreme pitching to transition between modes, where increased critical angle of attack of blown wings improves control and stability. The embodiments primarily illustrated as top plan view of the PPLA in hover mode, or frontal view in forward flight, but the description uses orientation terms to be understood with respect to forward flight, regardless as to whether this is consistent with a primary intended use of the PPLA.

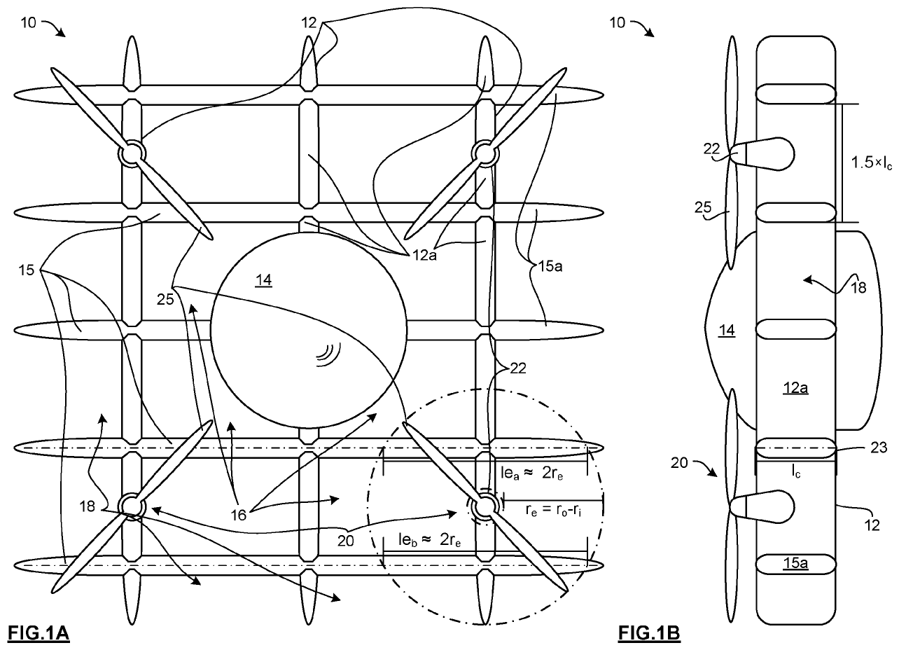

FIGS. 1A,B are schematic views of a first embodiment of a PPLA 10 in accordance with the invention. FIG. 1A is the primary view. The PPLA 10 is a lattice-form aerodyne, formed of 5 wings 15, 3 vertical stabilizers 12 (segmented by the wings into 18 stabilizer segments 12a), and a hold 14 located at a centre of the PPLA 10. Herein parts that are multiply instantiated are identified by selecting a few instances in a first drawing, and fewer in other figures, to avoid many labels. However all instances are understood to be encompassed by the reference identifier.

A characteristic of a lattice-form PPLA is the formation of a 2D array of bays, surrounded by baylets. Herein a ‘bay’ refers to a free-space passage through the PPLA, bounded by wings, stabilizers, and holds, or other support members, where the passage is surrounded on all sides. A baylet is similarly a passage for air, or duct, but is not completely surrounded, for example, a baylet may be surrounded on 3 sides. In the first embodiment, there are 8 bays 16, and 12 baylets 18. The manifestation of baylets is provided by wings 15 extending beyond (span-wise) the stabilizers (defining wing tips 15a), and stabilizers 12 extending beyond top and bottom wings.

These extensions are useful for protecting proprotors from tip strike, without incurring costs and weight penalties of shrouds or ducting. While shrouds can improve thrust, and improve control over airflow from proprotors, they add substantial weight and cost to the design. A simple and effective structure is provided by limiting PPLA designs nominally to horizontal wings, and vertical stabilizing struts.

The illustrated wing tips 15a extend beyond stabilizers 12 by about 40% of the span, and therefore the peripheral stabilizers 12 are at about 60% of the span. By providing the peripheral stabilizers 12 within 60-90% of span, in-plane wind load on the structure has limited preferential effect on the structure. If the stabilizers 12 (except the middle stabilizer as shown) were replaced with minimal bracing of reduced aerodynamic interaction, the PPLA would be better designed for forward flight, however in hover mode a substantial difference in drag between a cross-wind aligned with the wings, and one at aligned with the stabilizer would be encountered. The loads would differ widely based on an angle of the wings to the gust in hover, and so the workload to land may be highly dependent on prevailing conditions, orientation of the craft with respect to gusts. Applicant notes that approximately cylindrical designs can be provided to reduce the angular dependence, such as embodiments 2.

As best seen in FIG. 1A, four proprotors 20 are provided, their hubs 22 supported on respective stabilizer segments 12a midway between wings 15. It will be noted that in comparison with a vast majority of PPLAs currently designed, proposed, or in service, the proprotors 20 may have larger blades 25 and their hubs 22 are located closer to a centre of the aerodyne (where a centrebody hold 14 is). This increases a surface of blown wing, relative to the prior art. By maximally separating proprotors, in hover mode, the torque contributions from each are increased relative to that of the PPLA 10. For example the X PlusOne™ is a tailsitter that has maximally separated proprotors, and may have reasonably good control in hover mode, but challenges in control during pitch transition, which would be made as quickly as possible given the ideal location of the top and bottom proprotors of the X PlusOne.

Leveraging blown wing enhancement is an entirely different approach. The pitch transition can be slower and under control as will be required for flights that pitch transition in constrained spaces, or under gusting conditions. Each proprotor 20 produces thrust, and also projects air over two respective wings 15, increasing lift as well as drag. As shown, each wing 15 is symmetric, in that a camber line 23 (see FIG. 1B), is linear, and is also the chord (length l_{c}). To ensure substantially unimpeded airflow over each wing 15 in each bay 16, the separation of the wings should be at least about 1.25×l_{c}, although with a substantial penalty in the lift to drag ratio, a separation may be between 0.75×l_{c} and 1.25×l_{c}, especially if the wings are staggered, as explained hereinbelow. There is little aerodynamic advantage to a separation of adjacent wings above about 3×l_{c}, and in practice a separation of wings is expected to be between 1.25 to 2.5×l_{c}. Thus, like the Graham's CPA, this design has wings that are rather compact in the fore-aft direction, somewhat narrower in the span direction, and substantially higher, than other PPLAs.

As shown in FIG. 1B, the wings 15 are arrayed with fixed separation of 1.5×l_{c}. The stabilizers are shown further separated than the wings. Peripheral stabilizers and peripheral wings are respectively laid between 0.6 and 0.9 of the span, or the stabilizer extent, of the PPLA, as this provides short wing tips 15a, and stabilizer tips that improve tip strike protection without adding bulky shrouds. The extent of the stabilizer tips is not as great as the wing tips 15a, and so risk of tip strike is marginally higher from top and bottom than it is from side to side as shown in FIG. 1A. As ample stabilizing surface is provided by peripheral stabilizers 12, stabilizer tips may be omitted on the central stabilizer 12, or the central stabilizer may be omitted in favour of more minimal supports for the peripheral wings 15. This may afford a reduced weight with minimal penalty to control of the PPLA in hover mode, as the peripheral stabilizers and wings are the most critical buff bodies encountered by winds.

The proprotors 20 as shown in FIG. 1A, are arranged so that a middle wing 15, middle stabilizer 12, and hold 14 are not blown. Each proprotor 20 is identical, with a hub 22 and two blades 25, although in other embodiments any number of blades 25 may be used. They are symmetrically distributed at 4 corners of a rectangle inset with respect to the periphery of the PPLA such that the blade tips do not extend beyond any wing tip 15a or tip of a stabilizer. Each blade 25 blows exactly two wings equally as they are positioned midway between the wings on peripheral stabilizers 12. In a projected plane of FIG. 1A, the axes of the proprotors 20 form a rectangle, which is one example of a convex regular polygon. Each interior angle is 90°, and there is a negligible standard deviation of the interior angles.

Central hold 14 is shown as a longitudinally cylindrical body with an aerodynamic nose, although it could have a variety of shapes. For some scales, and use-case applications, a bulbous or rotund shape may be provided, as this maximizes an available size of a turret mount within the hold 14, while providing an aerodynamic cross-section. For larger scale craft, the hold may be a flying wing with a horizontally extended fuselage that can tilt with respect to the airframe. Essentially the turret would be mounted with an axis of rotation running span-wise to allow for tilting to compensate for rotation of the PPLA during pitch transition. Particularly if the hold is for to carrying passengers or payload that should remain upright throughout the pitch transition to (and from) forward flight, a rotary coupling may be provided. Rotation of the turret mount may be provided by a trunnion or at least one rail and rollers or slides for coupling the central body and turret mount. The rotation may be provided by an essentially passive joint, driven by a centre of gravity, although some dampeners may be preferred. The rotation may be limited to 120°. More degrees of freedom, and mechanical control, may be provided if the PPLA is for viewing or sensing. Alternatively, the central hold 14 may itself be mounted as a rotatable body over a limited range. In some designs, the hold is a wing.

FIG. 2 (i.e. FIGS. 2A,2B) schematically illustrates a first variant PPLA of the embodiment of the invention. Herein variants are described with common reference numerals and their descriptions are not repeated except to note differences. Each difference in each variant is combinable to produce further variants and embodiments that are expected to work as well as the collections of differences illustrated.

The first variant differs from the first embodiment in that: A) there are 4 instead of 3 stabilizers, providing a less square shape that has a measure of improved aerodynamics in forward flight at a slight expense to control in hover in that tilting on the span axis is inherently less controlled than in the axis of the stabilizers; B) the proprotors 20 are not all of a common size, in that two (larger) proprotors are mounted at the intersections of respective stabilizers and wings (a naturally more rigid mounting position, but one that typically leads to more drag), and accordingly blow substantially twice the radial extent (rₑ) of the supporting wing, as well as (in this case) approximately 1.76×rₑ of each of two adjacent wings (for a total of 3.76×rₑ), equally spaced from the supporting wing; C) there are 6 proprotors, arranged to form an irregular hexagon in the projective plane, which has 2 fold symmetry and internal angles of which consist of 4 instances of ~133.5° and 2 of ~93° (standard deviation is about 21°, or 17.5% of the 120° average); D) the wings are not equally spaced in that peripheral wings are closer to their neighbours than the three middle wings; E) the wings are not all of equal chord: to take advantage of the greater separation of the middle 3 wings, the middle wing has a larger chord while retaining a 1.25×l_{c} separation, and, as drawn, a 1.3×l_{c} separation is provided for the other wings; F) the wings are of various lengths to better shield the longer proprotors from tip strike; G) leading edges of the wings 15 are staggered by 15% of chord to improve lift in forward flight at the expense of symmetry that enhances control during hover (note that up to a 40% of chord positive stagger (top wing advanced relative to bottom) can improve lift to drag ratio-FIG. 2B particularly shows the staggering of the wings 15, and the chord length increase of the central wing); H) the centre hold 14 is not bulbous, but better suited to: reduce drag in forward flight occupying less of bays 16 that are blown to a higher degree, and support the inner stabilizers 12; I) stabilizer tips and wing tips of the peripheral stabilizers and wings meet to rigidify the structure, and enclose respective bays 16; and J) middle wing 15 is integrated with the hold 14. The hold 14 may have cutouts in alignment with the chord of the adjacent wings to ensure that at least a 0.75% of chord separation, to ensure a minimum gap to provide aerodynamically open bays 16 above and below the hold 14.

FIG. 3 is a schematic frontal view of a second variant of the first embodiment. The second variant is differentiated in that: it has 6 anhedral wings and 5 stabilizers; 2 of the 20 bays 16 are occupied by the central hold 14; the stabilizers are non-uniformly distributed in that a middle 3 are uniformly separated, but the peripheral two are further spaced; it has 8 proprotors, with two on each of 4 sides; and all wings and stabilizers are blown by at least 2 proprotors, except for the middle stabilizer. Dihedral and anhedral wings, and combinations of anhedral and dihedral wings, can be used. The central hold is not bulbous, but could be cylindrical (well suited to rotate on a span-wise axis).

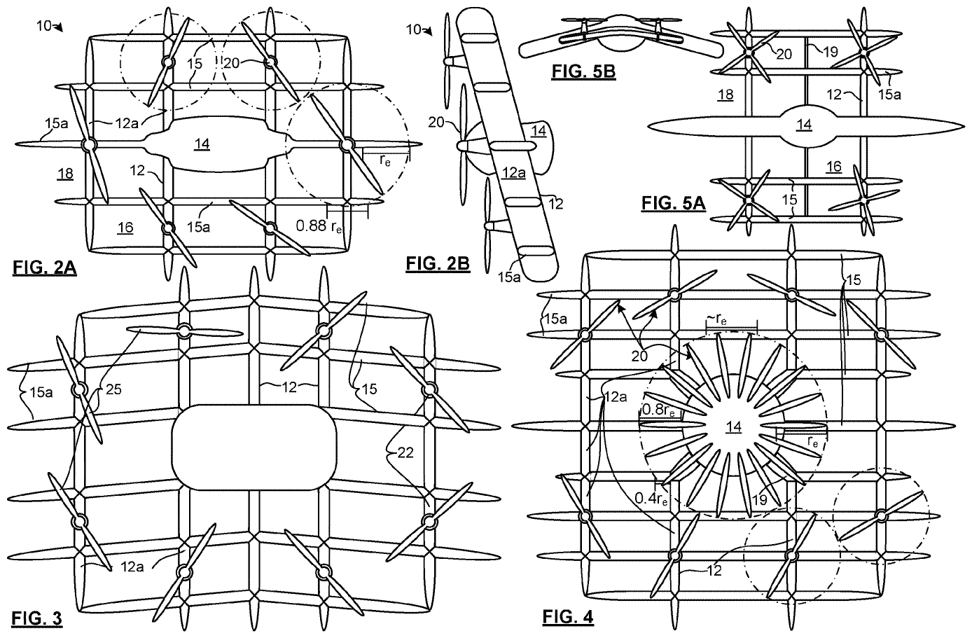

FIG. 4 is a schematic frontal view of a third variant of the first embodiment. The third variant is differentiated in 8 identified ways. A) The PPLA has 9 wings 15, 9 proprotors 20, and 4 stabilizers 12, (each of two wings and two stabilizers are segmented to decrease a cross-sectional area of plane blown by a central proprotor). B) To facilitate the segmentation of the inner-most paired wings, and middle two stabilizers, four supports 19 are added to couple ends of the segmented wings and stabilizers. C) Each peripheral proprotor is mounted at a respective junction between a wing and a stabilizer, which offers better mechanical support, increases drag on the airflow accelerated by the proprotors. D) The 9 wings are arranged with one middle wing, and upper and lower groups of 4 wings, the wings in each group being equally spaced. The two middle of each group of 4 are each blown by 4 peripheral proprotors, and the other two are blown by only two of the 8 peripheral proprotors. The use of two groups of wings, above and below a middle of the PPLA is recommended by symmetry, which confers control advantages in hover. As illustrated each of the 4 proprotors blows three of the four wings. E) The 8 peripheral proprotors, in the projected plane, define an irregular octagon, the vertices of which having 4 internal angles of 113°, and 4 of 157° as shown, and thus the angles have a standard deviation of ~23.5° on an average of 135°, or a 17.4% standard deviation. F) A single central proprotor is provided. While most proprotors sweep an annulus with a relatively small inner circle, this 18 blade proprotor does not revolve about a tip, but rather rotates around a distant axis. The segmentation described in B) greatly reduces a cross-section of wing blown by the central proprotor, mostly limited to the four supports 19, although about 0.8 rₑ of middle wing's leading edge is blown at each side, 0.4 rₑ of segmented wings at 4 locations are blown, and about one rₑ of each of the next most central wings is also each blown. As a result about 5.2 rₑ of leading edges of wings are blown by this proprotor, ignoring lift generated by supports 19. Each of the 8 peripheral proprotors blows about 4 rₑ of leading edge, similarly with the larger proprotor of the first variant. G) The wing tips 15a are minimized to sufficiently guard against tip strike of the peripheral proprotors, except the middle wing, which is longer, and preferably has a greater chord in view of a greater separation between its adjacent wings, and provides more lift in forward flight mode.

FIG. 5 (i.e. FIGS. 5A,B) are schematic (respectively frontal and top plan) views of a fourth variant that is distinguished by a simplified structure with 2 stabilizers 12, one frame support 19, 4 wings (in two groups); and an enlarged flying wing style hold 14 of greater spacing from the wings and greater chord. The wings are swept (back), as is the hold 14. The PPLA is driven by 4 4-bladed proprotors. The enlarged flying-wing hold 14 increases efficiency in forward flight but comes at a penalty for controlling hover as wind pushes differently on the structure at different angles. Depending on how extreme this chord is, weight distribution may further increase a moment of inertia of the PPLA making the pitching more difficult. Nonetheless the proprotors are blowing sufficient wing to allow for attachment over a substantially wider range of angles of attack than the prior art, which will improve control during pitch transition.

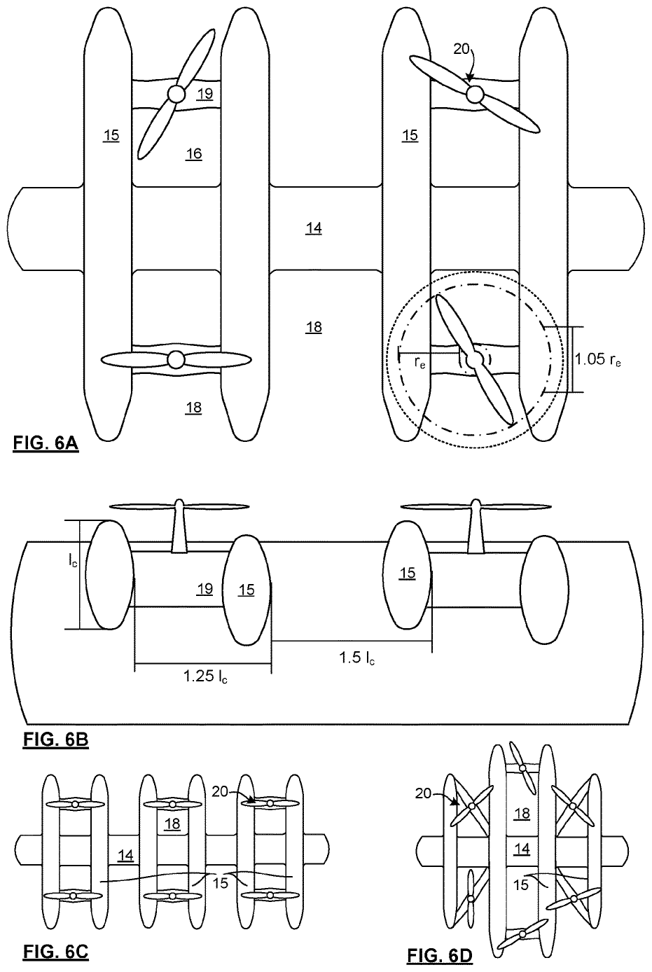

FIG. 6 (i.e. 6A,B) schematically illustrate a fifth variant that is distinguished by a simplified design consisting of one vertical stabilizer, which also serves as a hold 14; and 4 wings 15 (in 2 groups). Proprotor mounts 19 are provided midspan to provide stabilization. This variant shows a minimal 2.1×rₑ of leading edge blown to achieve the improved critical angle of attack, although this design would typically benefit from a larger diameter proprotor, for example with a 28% increase shown with dotted line, which would sweep more than 3×rₑ. The wings are shown having greater thickness than previous wings, and this results in a relatively high fraction of the swept cross-sectional area of the blades being blown, and the attendant drag of this design would not be preferable, but thinning these structures is possible with construction options, including local thinning in the vicinity of the proprotor. The principal advantage of this design is that the four bays 16 provide blown wings, and that 6 baylets 18 also provide some control for deflecting winds in hover flight. FIG. 6B shows stagger of the paired wings, which is an optional feature of this design, as well as a large disparity between chord of the hold 14 vs. chord of the wings 15.

The variants of FIGS. 4-6 show a progressive thickening and enlargement of the hold 14. At least by the fifth variant PPLA a third flight mode is suggested, wherein the vertical stabilizer becomes a flying wing, and the 4 wings, stabilizers. Thus with the axis X defined by the major axis of the hold 14, axis Y parallel to the proprotors axes of rotation, and axis Z defined by wings 15, a hover mode would begin with Y being vertical. Pitch transition to a flight stabilized mode involves rotation about Z, and throughout this transition, the blown wings improve control. At the end of the transition, X is approximately vertical. This orientation has blown wings, but also increased drag and may be not optimized for long haul flight. A second transition (roll transition) involves rotation (90°) about the Y direction from the stabilized mode. After roll transition the PPLA is oriented with the Z direction vertical, where the hold 14 provides a large wing for stable forward flight without the critical angle of attack improvements to control that are not as beneficial in forward flight. The hold 14 may be cambered for better lift in forward flight, at a penalty to sway control in flight stabilized mode.

FIG. 6C show a minor variant of the fifth variant with 3 pairs of wings, instead of 2. FIG. 6D shows a sixth variant having two more proprotors added to the fifth variant, and central wings of the respective pairs of longer span and chord than the distal wings. Furthermore, the mounting of the proprotors between the paired wings are provided on an-/di-hedral supports that serve also as lift-generating surfaces in forward flight (be it in the stabilized mode or after a roll transition). As a result of the mounting on an-/di-hedral supports, four of the bays, and four baylets, are triangular and not rectangular.

FIG. 7 is a schematic frontal view illustrating a seventh variant. The seventh variant is an 11-bay, 5-wing (two of which are segmented: a central wing is segmented by the hold 14; and the wing below this is segmented to provide an open duct for a hubless proprotor) PPLA. The seventh variant has only one line of symmetry. The bays include one large bay 16 below the hold 14. The PPLA would be symmetric in a second direction, if this lower wing were not segmented, and the bottom large proprotor were mounted to the wing, which is another embodiment of the present invention. The bays 16 above the hold 14 is divided in two by the unsegmented wing, which also supports the topmost proprotor. The PPLA in accordance with the present invention does not need to have all proprotors blow any wing, or all proprotors blowing some wing to leverage the blown wing effects that improve control during pitch transition.

The seventh variant shows a hubless proprotor mounted to the hold 14 and a bottom wing, and a proprotor mounted only to a single wing, but offset therefrom by a pylon. Proprotors mounted in this manner may not have their axis midway between wings. In particular, it is advantageous to disproportionately blow air above a wing, compared with below it, to increase lift. Thus the larger proprotor above the hold blows substantial air increasing lift for the one wing it blows, but the cutout bay offers blown wing surface area too. A gap between the tip of the blade and a top-most wing allows for less acceleration of air at the lower surface of this wing, and better lift production by the topmost wing.

The seventh variant has two paired proprotors that are preferably co-driven, or at least time-coordinated, so that they don't collide. The use of such proprotor sets are advantageous for increasing an area of blown wing, in a compact space. Each proprotor of the pair may be have independent pitch control, but they must operate at the same rate, to avoid collision, which is one disadvantage of the coordination. Of course chains of such proprotors can be used by grouping more than 2 together, if desired. Each paired proprotor is supported by mounts that produce 4 bays with the adjacent wings. The two sets of paired proprotors, top proprotor and hubless proprotor collectively provide 4 independently controlled thrust generators that permit quad-copter like control for the aircraft. It is only the paired proprotors that blow a length of 2.1×rₑ of the wings.

As illustrated, the wings all have a same chord, however the distal (top and bottom) wings may have a substantially larger chord as the separation of adjacent wings is greater. Four of the stabilizers supporting the distal wings extend substantially at an angle with respect to the vertical, in this embodiment. This can be provided to increase support, decrease blown area, and guide airflow through bays.

Hubless proprotors have some important advantages over propeller-style proprotors, as they leave an open flow path for fastest moving air through an essentially ducted space. As shown in the seventh variant, this may be used to blow wings, and with a smaller than shown bladed hubless proprotor, the surface of the wing blown may be more than 2.1×rₑ.

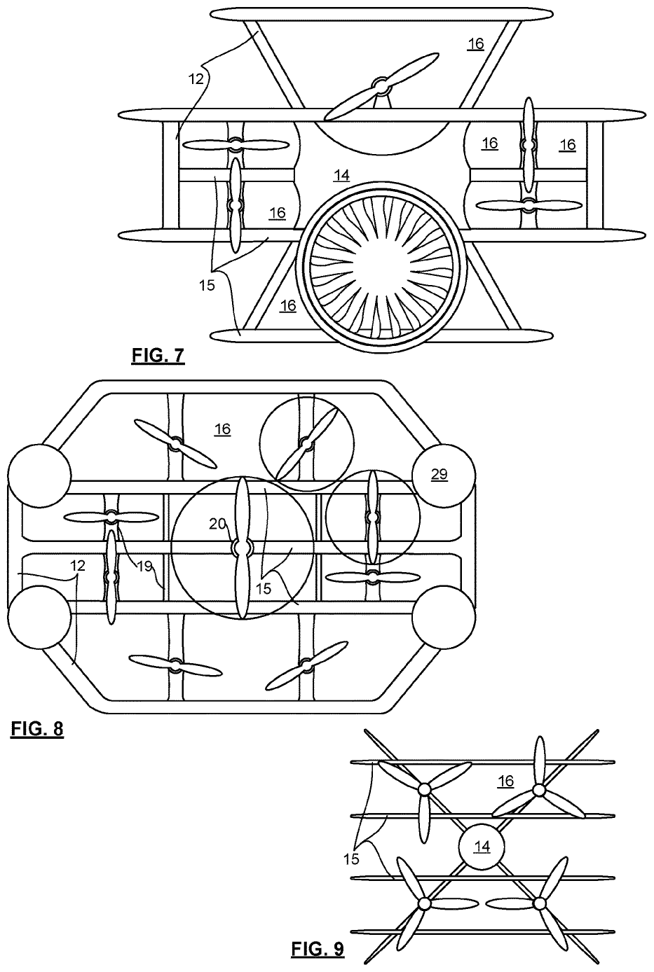

FIG. 8 schematically illustrates an eighth variant, having no hold 14, but four sensor mounts 29 distributed around the PPLA. The eighth variant has 9 proprotors (one large central proprotor and eight same-size proprotors, two pairs of which are paired for coordinated rotation), 5 wings, and 16 bays. Only 5 middle proprotors blow 2.1 rₑ of leading edge of wings. Top and bottom paired proprotors are asymmetrically mounted to increase lift by blowing air over top suction surfaces of respective wings to a greater extent than bottom pressure surfaces of wings, whereas the coordinated proprotors and large central proprotor are symmetrically mounted.

FIG. 9 schematically illustrates a ninth variant, differentiated in that: no stabilizer or vertical support is used in the design, rather all frame members are wings or an-/di-hedral supports; and the proprotors are 3-bladed. Two proximal (to centre) wings could be joined at their tips to provide a box-wing centre that would further rigidify the proximal wings and may further improve gust control in hover.

While the embodiments illustrated show proprotors that are mounted with axes parallel to chord of symmetric wings, it will be appreciated that a small (<16°, more preferably)<12° angle of the proprotor with respect to a heading vector of the PPLA is known to have advantages in controlling yaw, and may be used to advantage, as explained in “Performance and Control of Variable Pitch Proprotors for Multi-Scale Quadrotor Biplane Tail-sitters (QBiTs)” Presented at the Vertical Flight Society 75th Annual Forum & Technology Display, Philadelphia, Pennsylvania, May 13-16, 2019.

### EXAMPLES

Applicant has produced a prototype PPLA of lattice structure, with blown-wings referred to as LaBWing mini. FIGS. 10A,B are photographs thereof. The lattice structure has 4 wings and 3 stabilizers, and is otherwise similar to the design of FIG. 1. Each proprotor is mounted on respective stabilizer segments extending between the proximal and distal wings on a respective side of the hub. The lattice was 3D printed and commercial off the shelf parts were mounted to form the LaBWing mini. FIG. 10A shows the LaBWing mini on tarmac and FIG. 10B shows the LaBWing mini in flight. Applicant notes that this structure was not optimized for weight, aerodynamic performance, or fabrication, and the control algorithm for the PPLA was not optimized, and yet the LaBWing mini was able to maintain flight over a wide range of angles of attack, and to lose little altitude during pitch transition. Applicant considers this result a surprising advance in the art that, without the blown-wing enhancement, could not have been achieved.

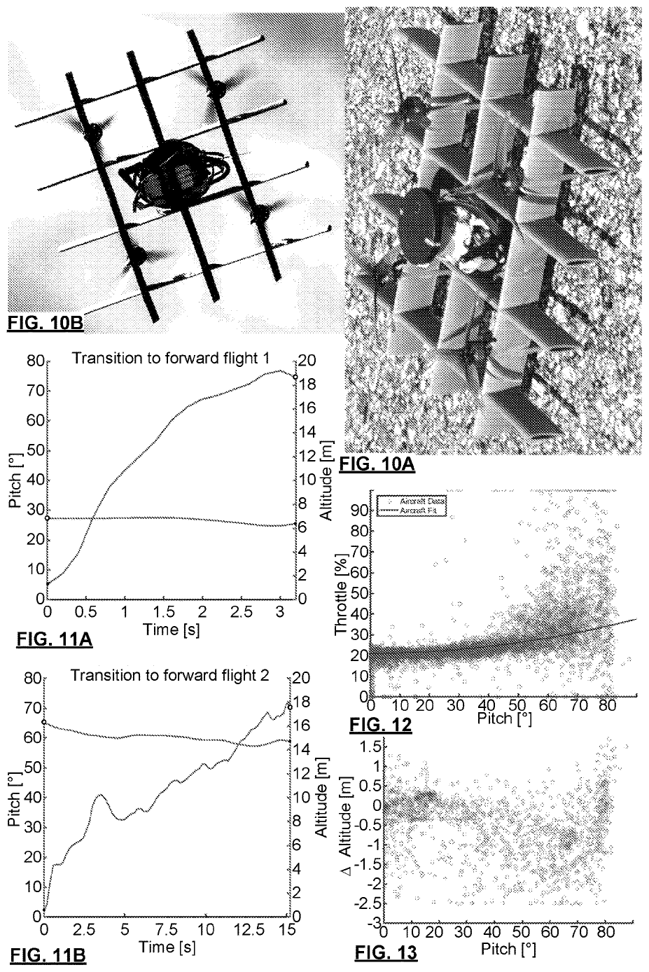

FIGS. 11A, B are graphs illustrating pitch and altitude of two different selected transitions to forward flight. Note, an open circle refers to intersection of a graphed line with a non-corresponding axis, and a closed circle refers to intersection of a graphed line with its corresponding vertical axis. In both cases, the LaBwing mini started off at a hover, a few degrees (resp. ~3° and) ~5° from perpendicular to the ground, and ended after achieving an angle of about 75°, which is well above an angle of attack for which stalling may occur. The altitude throughout the fast pitch transition varies by a very small amount (on the order of limits of the GPS chipset used to encode altitude), i.e. ~0.5 m. During the slow pitch transition, the altitude varied by about 1.5 m over a 15 s interval.

As noted hereinabove, a brief, controlled, pitch transition from hover to forward flight may be desired. FIG. 10A illustrates such a transition, in which little altitude is lost. Accordingly, to provide a margin for safety, a 2 m height is all that would be required for the LaBwing mini to pitch transition at this rate (i.e. within 3 s).

FIG. 10B illustrates pitch transition over a 15 s interval. The variation shows how a control algorithm is regularly correcting flight in view of gusts and dynamic effects on the LaBwing mini. The precipitous drop between the 3rd and 4th second is believed to be due to a gust and unlikely to be a failure of control. Between 30° and 40°, 86.6-76.6% of the force of the proprotors are oriented against gravity. While control is diminished throughout these angles, it is far less than the variation in angles between 50° and 65°.

FIG. 12 shows throttle as a function of pitch angle. An aircraft fit line was superposed on the scatter plot of aircraft data. Hover can be performed with relatively high efficiency with this structure, which is convenient for many use cases, such as Search and Rescue, and remote sensing and imaging. Pitch transition can demonstrably be provided without increasing throttle to about 35% in general, and depending on windspeed and heading it can be less. It is believed that pitch transition from hover to forward flight in a slow manner is impossible, and dangerous for most PPLA, and riskier when transitioning quickly because of the substantial loss of control.

With similar data points Applicant has estimated that the mean ground speed, correcting for wind and gusts, is about 20 m/s (or about 72 km/h). The flight control algorithms were designed conservatively to avoid pitch angles above 80°. While a best efficiency of the LaBwing mini is likely at around 88°, and drag could be reduced by as much as 3× operating in this range, forward flight control requires more study. Simulation of the LaBwing mini was shown to agree well with experimental results. The simulation indicates that a top speed of 150 km/h and a cruise speed of 120 km/h are reasonable.

FIG. 13 is a scatter plot of a deviation of altitude from a commanded altitude, as a function of pitch. Applicant notes that LaBwing mini is a relatively light drone (750g), nonetheless stable altitude control was observed at any pitch angle. Larger, heavier vehicles would be expected to have better altitude control due to inertial effects. Fixed wing lift is seen to start helping around 60-65°.

The essential features of the PPLA described herein are shown with a minimum of view-obstructing alternative elements. It will be appreciated by those of skill in the art that a PPLA can be equipped with numerous devices and systems to achieve particular functions.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A proprotor-driven powered-lift aircraft (PPLA) wherein, each of which proprotors:
is driven about a respective axis that is no more than 16° from a heading vector of the PPLA in nominal forward flight;
sweeps a respective annulus of radial extent rₑ that covers, by axis-orthogonal projection along the heading vector, a collective length of at least 2.1×rₑ of leading edges of two or more wings,
where at least one set of at least one of the proprotors is on each side of: a pitch axis of the PPLA, and on each side of a yaw axis of the PPLA, and the sets on opposite sides of the pitch and yaw axes are operable independently of eachother.

2. A proprotor-driven powered-lift aircraft (PPLA) having at least three substantially parallel wings and at least four proprotors, where each of which proprotors:
has a longitudinal axis no more than 16° from a heading vector of the PPLA in forward flight;
is affixed to a bracing extended between two of the at least three wings; and
sweeps an annulus of radial extent rₑ sufficient to cover at least 2.1×rₑ of leading edges of two or more wings, including at least 2% of a span of each of the two wings.

3. The PPLA according to claim 1 wherein axes of at least four of the at least four proprotors are arrayed to define a convex polygon in a plane of the axis-orthogonal projection along the heading vector, the polygon having no interior angle less than 35°, and a standard deviation of the interior angles is less than 50% of the average of the interior angles.

4. The PPLA according to claim 1 wherein a constellation of the axes in a plane of the axis-orthogonal projection along the heading vector is symmetric about a projection of the yaw axis and/or pitch axis of the PPLA.

5. The PPLA according to claim 1 comprising an airframe structure supporting the wings that comprise at least four stacked airfoils, where each airfoil:
has a chord oriented generally axially;
has a chord length l_{c}; and
is separated from an adjacent airfoil by a distance of at least 1.5×l_{c}, and less than 15×l_{c}.

6. The PPLA according to claim 5 wherein the supporting structure comprises substantially full chord struts having aerodynamic contours to serve as vertical stabilizers separating adjacent airfoils, and the full chord struts, airfoils, and hold define at least 4 bays for airflow within a periphery of the PPLA: each bay defined between two adjacent struts or a hold and a strut, and between two airfoils or an airfoil and a hold.

7.-8. (canceled)

9. The PPLA according to claim 6 wherein the vertical stabilizers include a set that extend between each adjacent airfoil on both sides, at between 55% and 100% span.

10. The PPLA according to claim 6 wherein the PPLA:
comprises a lattice structure produced by the wings and stabilizers;
does not have a canard or empennage;
further comprising a rotund central body with the hold, the central body comprising a turret mount for at least a passive, 1 DoF rotation based on a center of gravity, rotation provided by a trunnion or at least one rail and rollers or slides for coupling the central body and hold to the support structure;
substantially consists of the airfoils, supports, and the hold, and has no flight control surfaces other than the proprotors;
is a tail-sitter with landing gear facing or deployable to face away from the proprotors; or
is a nose-sitter with landing gear facing or deployable in front of the proprotors.

11.-13. (canceled)

14. The PPLA according to claim 1 wherein two neighbouring proprotors sweep overlapping annuli, the proprotors having coordinated phase.

15. The PPLA according to claim 1 wherein the wings are symmetric such that its camber line is its chord line, the wings are fixedly mounted to an airframe with the camber line.

16.-18. (canceled)

19. The PPLA according to claim 2 wherein axes of at least four of the at least four proprotors are arrayed to define a convex polygon in a plane of the axis-orthogonal projection along the heading vector, the polygon having no interior angle less than 35°, and a standard deviation of the interior angles is less than 50% of the average of the interior angles.

20. The PPLA according to claim 2 wherein a constellation of the axes in a plane of the axis-orthogonal projection along the heading vector is symmetric about a projection of the yaw axis and/or pitch axis of the PPLA.

21. The PPLA according to claim 2 comprising an airframe structure supporting the wings that comprise at least four stacked airfoils, where each airfoil:
has a chord oriented generally axially;
has a chord length l_{c}; and
is separated from an adjacent airfoil by a distance of at least 1.5×l_{c}, and less than 15×l_{c}.

22. The PPLA according to claim 21 wherein the supporting structure comprises substantially full chord struts having aerodynamic contours to serve as vertical stabilizers separating adjacent airfoils, and the full chord struts, airfoils, and hold define at least 4 bays for airflow within a periphery of the PPLA: each bay defined between two adjacent struts or a hold and a strut, and between two airfoils or an airfoil and a hold.

23. The PPLA according to claim 22 wherein the vertical stabilizers include a set that extend between each adjacent airfoil on both sides, at between 55% and 100% span.

24. The PPLA according to claim 2 wherein the PPLA:
comprises a lattice structure produced by the wings and stabilizers;
does not have a canard or empennage;
further comprising a rotund central body with a hold, the central body comprising a turret mount for at least a passive, 1 DoF rotation based on a center of gravity, rotation provided by a trunnion or at least one rail and rollers or slides for coupling the central body and hold to the support structure;
substantially consists of the airfoils, supports, and a hold, and has no flight control surfaces other than the proprotors;
is a tail-sitter with landing gear facing or deployable to face away from the proprotors; or
is a nose-sitter with landing gear facing or deployable in front of the proprotors.

25. The PPLA according to claim 2 wherein two neighbouring proprotors sweep overlapping annuli, the proprotors having coordinated phase.

26. The PPLA according to claim 2 wherein the wings are symmetric such that its camber line is its chord line, the wings are fixedly mounted to an airframe with the camber line.
